(19) United States
(12) Patent Application Publication
(10) Pub. No.: US 2021/0025321 A1
(43) Pub. Date: Jan. 28, 2021

(54) BELT-DRIVEN ATTACHMENT SYSTEM

(71) Applicant: Consolidated Equipment Group, LLC, Alexandria, MN (US)

(72) Inventors: James G. Johnson, Bemidji, MN (US); Shane Voxland, McIntosh, MN (US); Timothy J. Berg, St. Paul, MN (US); Todd Olson, Carlos, MN (US)

(21) Appl. No.: 16/938,615

(22) Filed: Jul. 24, 2020

Related U.S. Application Data
(60) Provisional application No. 62/878,855, filed on Jul. 26, 2019.

(51) Int. Cl. F02B 67/06; A01D 34/00; B62D 53/00

(52) U.S. Cl. CPC F02B 67/06; F02B 2275/06; B62D 53/00; A01D 34/001

(57) ABSTRACT

A belt-driven attachment system is disclosed. The attachment system includes a mobile power unit with a drive pulley and a power unit interface for connection of an attachment. The attachment includes at least one driven pulley and a first belt guide to maintain the belt aligned with the at least one driven pulley when tension on the belt is released. The attachment also includes an idler pulley and an idler position assembly coupled to the idler pulley. The idler position assembly provides a first position setting for the idler pulley in which tension on the belt is maintained and a second position setting for the idler pulley in which tension on the belt is released. The attachment also includes a second belt guide to maintain the belt aligned with the idler pulley when tension on the belt is released.

This application claims priority to U.S. Provisional Application No. 62/878,855, filed on Jul. 26, 2019, entitled “BELT-DRIVEN ATTACHMENT SYSTEM”, the contents of which is hereby incorporated herein by reference.

### BACKGROUND

Attachments for construction, landscaping, and farming machines are common. The attachments come in many forms and allow a single power machine to perform different tasks by changing the attachment connected to it. Example machines that are designed to have removable attachments connected thereto include loaders of various forms such as a skid steer, tracked loader, and tractor mounted loaders. These machines include a coupling mechanism that allows different attachments to be connected and disconnected from the machine. In turn, different attachments include their own coupling mechanism designed to mate with the machine's coupling mechanism so that the attachment can be connected to and disconnected from the machine. Different attachments are designed to perform different tasks for the machine enabling a single machine to perform different tasks by switching which attachment is connected to it.

Many different types of attachments exist including buckets, grapples, earth augers, backhoes, hydraulic powered brooms, grading blades, fertilizer spreaders, hydraulic breakers, landscape seeders, log splitters, mowers, mulchers, packers, pallet forks, asphalt planers, post drivers, rakes, rotary tillers, shears, skid plates, soil conditioners, snow blowers, snow plows, snow pushers, stump grinders, sweepers, teeth bars, tree pullers, tree spades, and trenchers.

Attachments can be powered or unpowered. Powered attachments include one or more components that can move via power provided from the machine to the attachment. Example powered attachments include a brush—in which a cylindrical brush rotates with power from the machine, a grapple—in which a top and/or bottom fingers move to close and open the grapple with power from the machine, and a mower—in which one or more blades rotate with power from the machine. The power from the machine is typically provided via hydraulic pressure. That is, hydraulic hoses are connected between the attachment and the machine and a hydraulic pump on the machine provides force to move the components of the powered attachment via hydraulic fluid flowing therebetween. Unpowered attachments are attachments without any component that moves via power from the machine. Example unpowered attachments can include a bucket, forks, and a bale spear.

The coupling mechanism to couple an attachment to a machine can be designed to enable efficient, yet secure, connection and disconnection of an attachment to the machine. One type of coupling mechanism includes a mounting plate disposed on a pair of hydraulically movable arms of the machine. The mounting plate is a flat surface that provides a rigid contact area for a mating plate of the attachment to bear against during connection with the machine. Thus, the attachment has its own mounting plate (also referred to herein as a “mating plate”) which is another flat rigid surface configured to bear against the mounting plate of the machine during connection therewith. The mating plate on the attachment can also define one or more flanges proximate a top of the mating plate. The flanges can be configured to hook onto the top edge of the mounting plate and enable the arms of the machine to pick up the attachment by engaging the top edge of the mounting plate with the flange and bringing the flat surface of the mating plate into contact with the flat surface of the mounting plate. These coupling mechanisms typically include one or more pins on the mounting plate that extend through corresponding apertures defined near the mating plate to secure the attachment to the machine.

### BRIEF DESCRIPTION

Embodiments for a belt-driven attachment system are provided. The attachment system includes a mobile power unit includes a plurality of wheels or tracks, a drive pulley, and a power source coupled to the plurality of wheels or tracks to provide motive power for the mobile power unit. The power source is coupled to the drive pulley to rotate the drive pulley. The attachment system also includes a power unit interface and an attachment for the mobile power unit. The attachment includes an attachment interface configured to removably secure the attachment to the mobile power unit by fastening to the power unit interface of the mobile power unit. The attachment also includes at least one driven pulley defining at least one groove for a belt and a first belt guide opposing a portion of the at least one groove of the at least one driven pulley. The first belt guide is configured to maintain the belt aligned with the at least one groove of the at least one driven pulley when tension on the belt is released. The attachment also includes an idler pulley defining at least one groove for the belt, a tensioner coupled to the idler pulley to provide tension on the belt, and an idler position assembly coupled to the idler pulley. The idler position assembly provides a first position setting for the idler pulley in which tension on the belt is maintained and a second position setting for the idler pulley in which tension on the belt is released. The attachment also includes a second belt guide opposing a portion of the at least one groove of the idler pulley, the second belt guide configured to maintain the belt aligned with the at least one groove of the idler pulley when tension on the belt is released.

Embodiments for an attachment for a mobile power unit are also provided. The attachment includes an interface configured to removably attach to the mobile power unit, at least one driven pulley defining at least one groove for a belt, and a first belt guide opposing the at least one groove of the at least one driven pulley to maintain the belt aligned with the at least one groove of the at least one driven pulley when operating tension on the belt is released. The attachment also includes an idler pulley defining at least one groove for the belt, a tensioner coupled to the idler pulley, and an idler position assembly coupled to the idler pulley. The idler position assembly is configured to move the idler pulley between a first position and a second position, the first position maintaining operating tension on the belt and the second position having operating tension released. The attachment also includes a second belt guide opposing the at least one groove of the idler pulley to maintain the belt aligned with the idler pulley when operating tension on the belt is released.

Embodiments for a walk-behind power unit are also provided. The walk-behind power unit includes a frame, a single axle for a plurality of wheels mounted on the frame, and an operator interface at a rear of the walk-behind power unit. The operator interface includes a plurality of handle bars rigidly coupled to the frame for non-assisted maneuvering of the power unit by an operator walking behind. The power unit also includes a drive pulley mounted on the frame for providing belt-driven power to a powered attachment and a power source mounted on the frame. The power source is coupled to the plurality of wheels to provide motive power for the power unit. The power source is also coupled to the drive pulley to rotate the drive pulley. The power unit also includes a mounting plate at a front of the walk-behind power unit. The mounting plate is configured to have the powered attachment removably mounted thereto, the mounting plate defining a vertically oriented contact surface for contacting a corresponding surface of the powered attachment and an edge for engaging a flange of the powered attachment.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a perspective view of an example mobile power unit and an example attachment that include an example belt-driven attachment system as describe herein;

FIG. 2 is a perspective view of the attachment of FIG. 1 connected to the power unit of FIG. 1;

FIGS. 3A and 3B are enlarged views of an example power unit interface of the power unit of FIGS. 1 and 2;

FIGS. 3C and 3D are enlarged views of an example attachment interface of the attachment of FIGS. 1 and 2;

FIG. 4 is a side view of the power unit of FIGS. 1 and 2 with the right wheel removed;

FIGS. 5A-5E are different views showing an example pin position assembly for moving the movable pin(s) of the mounting plate from a rear of the power unit;

FIG. 6 is a top view of the attachment of FIGS. 1 and 2 connected to the power unit of FIGS. 1 and 2 with portions of the safety guard and power unit cut-away to see underneath;

FIG. 7A is a cross-sectional view of an example belt guide for the driven pulley of the attachment of FIG. 1;

FIG. 7B is a cross-sectional view of an example belt guide for an idler pulley of the attachment of FIG. 1; and

FIG. 8 is a top view of another example attachment connected to the power unit of FIG. 1 with portions of the safety guard and power unit cut-away to see underneath.

### DETAILED DESCRIPTION

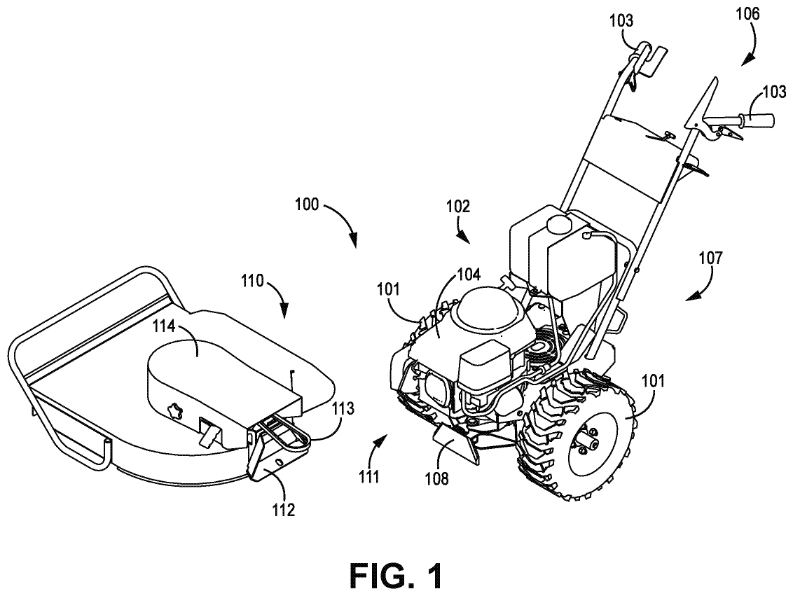

FIG. 1 is a perspective view of an example mobile power unit 102 and attachment 110 that include an attachment system 100 which provides an efficient means of connecting and disconnecting belt-driven attachments. The mobile power unit 102 includes a power source 104 that can provide motive power for the mobile power unit 102 and power for a powered attachment connected thereto. Any suitable power source 104 can be used including an engine that burns gasoline, diesel fuel, or propane or an electric motor. The mobile power unit 102 can also include wheels 101 and/or tracks which are powered by the power source 104 to provide the motive power for the mobile power unit 102. The mobile power unit 102 also includes an operator interface 106. The operator interface 106 provides handles, buttons, triggers, levers, pedals, and/or other mechanisms by which the operator can control the mobile power unit 102 and any attachment connected thereto.

The example mobile power unit 102 shown in FIG. 1 is a walk-behind unit in which an operator stands/walks behind it while operating. The walk-behind unit shown in FIG. 1 includes an operator interface 106 disposed at a rear 107 of the unit. The operator interface 106 includes two handle bars 103 that are rigidly coupled to a frame of the power unit 102 enabling the operator to push, pull, turn, tip, and/or otherwise maneuver the power unit 102 by manual (non-assisted) physical manipulation via the handle bars 103. In an example, the motive power for the walk-behind unit can include assisted (powered) forward and backward motion by driving the wheels/tracks 101 on opposite sides at the same speed and can provide assisted turning by moving the wheels/tracks 101 on opposite sides at differing speeds (e.g., by differing the driving force or braking one of the wheels/tracks 101). In other examples, the motive power for the walk-behind unit can include assisted forward and backward motion, but no assisted turning, instead requiring the operator to manually turn the unit.

In other examples, the mobile power unit 102 can have other forms, such as providing a seat or platform for the operator to sit or stand on and can include or exclude a corresponding cage or cab for the operator. The mobile power unit 102 can have any suitable size and horsepower.

The mobile power unit 102 also includes a power unit interface 108. The power unit interface 108 is a physical structure to which an attachment 110 is physically connected and disconnected, allowing the attachment 110 to be removably connected to the mobile power unit 102. FIG. 1 shows the attachment 110 disconnected from the power unit 102. Any suitable attachment can be connected to the power unit interface 108 including a mower as shown in FIG. 1, a powered brush, snow blower, or a tiller.

In an example, the power unit interface 108 is disposed at a front 111 of the power unit 102. The front 111 of the power unit 102 is the end facing the same direction as the primary direction of travel for the power unit 102. The rear 107 is the end reverse of the front 111. The power unit 102 can also be disposed such that the attachment 110 while attached to the power unit 102 is disposed in front of the operator while the operator is operating the power unit 102. Thus, the operator can easily view the attachment 110 connected to the power unit 102 during operation.

To easily and securely connect to the mobile power unit 102, each attachment 110 for the mobile power unit 102 includes an attachment interface 112 for removable connection with the power unit interface 108 of the mobile power unit 102. The attachment interface 112 is a physical structure with a configuration that corresponds to the power unit interface 108 such that the attachment interface 112 can connect with and be physically secured to the power unit interface 108. In an example, the power unit interface 108 can be pivoted about a vertical access into multiple different horizontal angle positions relative to the power unit 102 to change the angle of the attachment 110 while the attachment 110 is connected to the power unit 102. In an alternative example, the power unit interface 108 is non-pivotable with respect to the power unit 102.

The example attachment 110 is a powered attachment (mower) which is driven by one or more belts 113 from the power unit 102. That is, the belt(s) 113 are coupled between the power unit 102 and the attachment 110 to transfer power from the power source 104 of the power unit 102 to the drive component(s) (e.g., blade(s)) of the attachment 110. The attachment 110 and power unit 102 include suitable pulleys to enable the power transfer from the power unit 102 to the attachment 110 via the belt(s) 113. The belt(s) 113 can be disconnected from the power unit 102 and remain with the attachment 110 during disconnection of the attachment 110 from the power unit 102 (as shown in FIG. 1).

In an example, the attachment 110 includes one or more safety guards 114 covering one or more of the pulleys on the attachment 110 and/or portions of the belt(s) 113. The safety guards 114 can protect items and individuals from inadvertent contact with the fast-moving pulleys and belt(s) 113 during operation. In the example shown in FIG. 1, a single safety guard 114 covers all of the pulleys of the attachment 110.

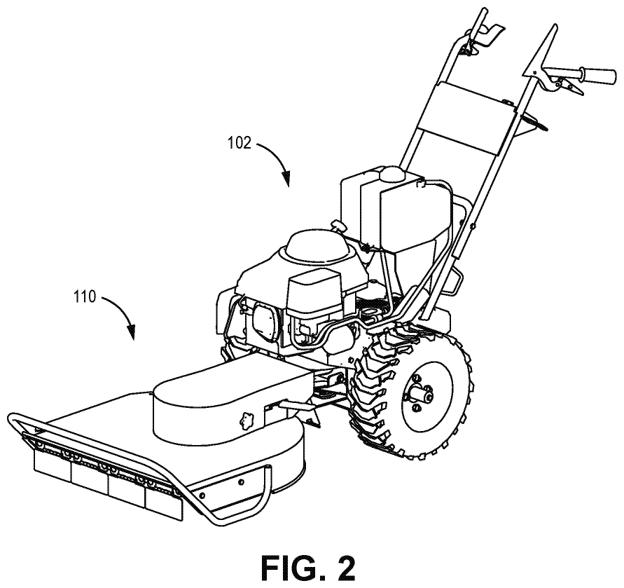

FIG. 2 is a perspective view of the attachment 110 connected to the power unit of FIG. 1. While the attachment 110 is connected to the power unit interface 108, the attachment 110 is physically attached to the mobile power unit 102. While the attachment 110 is connected to the mobile power unit 102, the attachment moves with the mobile power unit 102 such that motive power provided by the mobile power unit 102 moves both the mobile power unit 102 and the attachment 110 together. The connection between the attachment interface 112 and the power unit interface 108 can be a rigid connection whereby the translation (forward and backward movement) and orientation of the attachment 110 is locked to the mobile power unit 102. That is, in addition to moving forward and backward with the power unit 102, the attachment 110 also moves in an arc at the same rotational speed as the power unit 102 when the power unit 102 pivots about an axis. The rigid connection between the power unit 102 and the attachment 110 can also enable the attachment 110 to be raised up and possibly off the ground by lifting or angling the power unit interface 108 appropriately. The belt(s) 113 can be connected to both the attachment 110 and the power unit 102 during connection of the attachment 110.

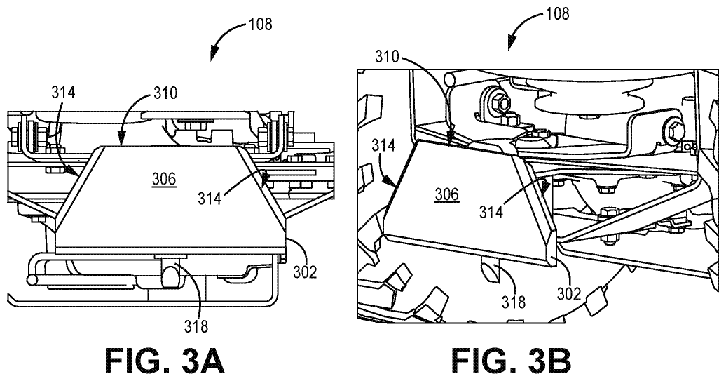

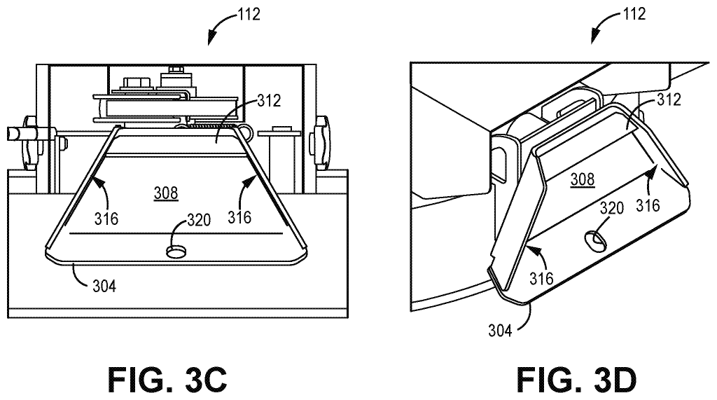

FIGS. 3A and 3B are enlarged views showing the example power unit interface 108 of the power unit 102. In the example shown in FIGS. 3A and 3B, the power unit interface 108 includes a mounting plate 302, which defines one or more rigid contact surfaces 306 against which a mating plate 304 (shown in FIGS. 3C and 3D) of an attachment 110 can bear. FIGS. 3C and 3D are enlarged views of an example attachment interface 112 of the attachment 110. The example attachment interface 112 in FIGS. 3C and 3D is a mating plate 304 that matches with the mounting plate 302 of the power unit interface 108. The mating plate 304 defines one or more rigid contact surfaces 308 that bear against the rigid contact surface 306 of the mounting plate 302 of the power unit interface 108. The contact surfaces 306, 308 of the mounting plate 302 and mating plate 304 bear against each other over a large enough area to form the rigid connection (orientation and translation) therebetween. In an example, the contact surfaces 306, 308 of the mounting plate 302 and the mating plate 304 are generally planar.

The mating plate 304 and mounting plate 302 also include structures to hold their two contact surfaces 306, 308 together. These structures can include a flange 312 defined on the mating plate 304 that hooks onto an edge 310 defined in the mounting plate 302. The flange 312 is a structure that projects from and generally normal to the contact surface 308 of the mating plate 304. The corresponding edge 310 defined in the mounting plate 302 can be a surface that faces generally perpendicular to or angled downward away from the contact surface 306 of the mounting plate 302. In an example, the flange 312 is disposed proximate a top of the contact surface 308 of the mating plate 304 and is configured to hook onto the edge 310, which is disposed proximate a top of the contact surface 306 of the mounting plate 302. The flange 312 can be rounded downward as it extends from the contact surface 308 or include a structure that angles downward at its outward edge to enable the flange 312 to hook onto the edge 310 defined by the mounting plate 302.

To connect the mating plate 304 to the mounting plate 302, the contact surface 306 of the mounting plate 302 can be positioned facing and aligned with the contact surface 308 of the mating plate 304, with the edge 310 defined in the mounting plate 302 lower than the flange 312 of the mating plate 304. The top portion of the contact surface 306 of the mounting plate 302 can then be brought into contact with the contact surface 308 of the mating plate 304. Then the mounting plate 302 can be slid up to engage the edge 310 defined in the mounting plate 302 with the flange 312 of the mating plate 304. Once the flange 312 is hooked onto the edge 312 of the mounting plate 302, the mounting plate 302 can be raised to bring the contact surfaces 306, 308 of the mounting plate 302 and the mating plate 304 into full contact.

In an example, the mounting plate 302 is disposed such that the contact surface 306 is oriented generally vertical during normal operation of the power unit 102. The contact surface 306 can also be oriented generally normal to the forward direction of travel for the power unit 102. In examples where the mounting plate 302 pivots about a vertical access to change the angle of the attachment 110 relative to the power unit 102, the mounting plate 302 can include a position setting in which the contact surface 306 is generally normal to the forward direction of travel.

The mating plate 304 is disposed such that its contact surface 308 is also oriented generally vertical while the attachment 110 is resting, disconnected, on the ground, such that the edge 310 of the mounting plate 302 can be engaged with the flange 312 of the mating plate 304 and the contact surfaces 306, 308 can be brought into contact by moving the power unit 102 towards the resting attachment 110. In an example, the contact surfaces 306, 308 are oriented sufficiently vertical such that the top edge (310) of the mounting plate 302 can engage the flange 312 sufficiently to lift at least a portion of the attachment 110 as the mounting plate 302 is raised.

In the example shown in FIGS. 3A and 3B, the mounting plate 302 defines angled side edges 314 proximate opposite lateral sides of the contact surface 306 of the mounting plate 302. The side edges 314 are surfaces that face generally perpendicular to the contact surface 306 of the mounting plate 302. The side edges 314 are angled inward as they progress upwards (towards a top of the mounting plate 302). The angled side edges 314 can form all or a portion of each side of the mounting plate 302. Along with a horizontal top and bottom edges proximate the contact surface 306, the angled side edges 314 can form a trapezoidal shape for the contact surface 306, wherein the top lateral dimension of the trapezoid is smaller than the bottom lateral dimension.

The mating plate 304 on the attachment 110 can include angled side flanges 316 that correspond to the angled side edges 314 of the mounting plate 302. The angled side flanges 316 are structures that extend generally perpendicular to and proximate opposite sides of the contact surface of the mating plate 304. The angled side flanges 316 are disposed at an angle to vertical, such that as they progress upwards (towards a top of the mating plate 304) they are closer together. The angled side flanges 316 are spaced apart from one another a distance that corresponds to (e.g., is slightly larger than) the distance between the angled side edges 314 of the mounting plate 302. The angled side flanges 316 can also be disposed at a common angle with the angled side edges 314. Similar to the mounting plate 302, the contact surface 308 can take the shape of a trapezoid, wherein the top lateral dimension of the trapezoid is smaller than the bottom lateral dimension. In use, the angled side edges 314 and angled side flanges 316 work together to align the contact surfaces 306, 308 of the mating plate 304 and the mounting plate 302 during connection. As the mounting plate 302 is raised prior to engagement of the edge 310 with the flange 312, the angled side edges 314 can contact the angled side flanges 316 to adjust the relative lateral position of the mounting plate 302 and the mating plate 304 such that they are better in alignment.

In an example the mounting plate 302 can include one or more movable pins 318 that are configured to extend into one or more corresponding apertures 320 defined in a mating plate 304. The pin(s) 318 and aperture(s) 320 are used to secure the mating plate 304 to the mounting plate 302, so that the attachment 110 cannot easily disconnect unintendedly. In use, bringing the contact surfaces 306, 308 of the mounting plate 302 and mating plate 304 are into contact during connection, with the flange 312 engaged with the edge 310, will also bring the pin(s) 318 into alignment with the aperture(s) 320 of the mating plate 304. Then, the pin(s) 318 can be extend into the aperture(s) 320 to secure the mating plate 304 to the mounting plate 302. The pin(s) 318 can extend (move) in a direction generally parallel with the contact surfaces 306, 308. While the pin(s) 318 is/are engaged in the aperture(s) 320, the pin(s) 318 can restrict movement of the mating plate 304 away from the mounting plate 302 thereby securing the two together during use.

To disconnect the attachment 110, the pin(s) 318 (if present) can be retracted, withdrawing them from their corresponding aperture 320. The mounting plate 302 can then be lowered with the attachment 110 resting on the ground until the edge 310 of the mounting plate 302 disengages from the flange 312 of the mating plate 304. The power unit 102 can then be moved backward, away from the attachment 110. The power unit 102 is now disconnected from the attachment 110 and can be moved independently of the attachment 110.

In other examples, other power unit interfaces 108 and mating attachment interfaces 112 can be used including a quick coupler—commonly used for excavator buckets, a bolt-on style coupler, or another connection mechanism currently existing or to-be-developed.

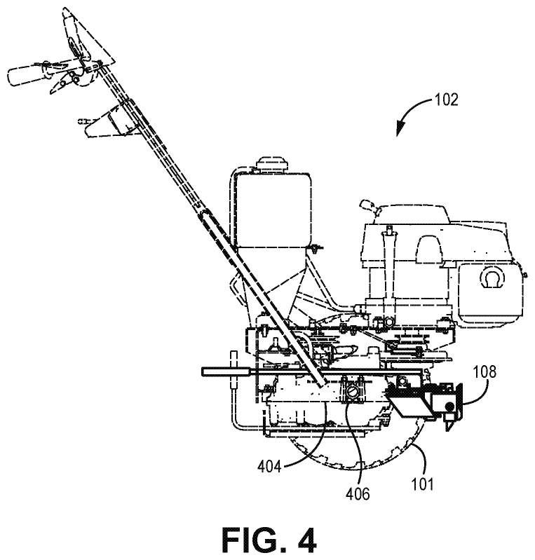

FIG. 4 is a side view of the power unit 102 of FIGS. 1 and 2 with the right wheel 101 removed. In an example, the power unit interface 108 is rigidly coupled to the frame 404 of the power unit 102. The frame 404 of the power unit 102 is the structural portion of the power unit 102 that provides the main support for, and to which the wheels/axle(s) 406, the power source 104, and any operator seat or platform are rigidly coupled. With the power unit interface 108 rigidly coupled to the frame 404, the power unit interface 108 cannot move relative to the frame 404. This is in contrast to an attachment mounting plate of a skid steer, which is mounted on movable arms of the skid steer, allowing its attachment mounting plate to move upward, downward, inward, and outward with respect to its frame via movement of the arms. Instead of using arms to move the power unit interface 108, the example power unit 102 shown herein is configured to tip its frame 404 forward and back to move the power unit interface 108 upward and downward. The power unit 102 includes only a single axle 406 (e.g., two half-axles (split axle), one solid axle), enabling the frame 404 of the power unit 102 to be tipped forward and backward about its axle 406. Thus, during connection of an attachment 110 using a mounting plate style power unit interface 108, the mounting plate 302 of the power unit 102 is moved downward by tipping the power unit 102 forward. The power unit 102 is then moved forward towards the attachment 110 and the power unit 102 is tipped backward once the mounting plate 302 is aligned with the mating plate 304 of the attachment 110. Tipping the power unit 102 backward raises the mounting plate 302 upward to engage the edge 312 of the mounting plate 302 with the flange of the mating plate 304 on the attachment 110. Advantageously, this design of power unit 102 and interfaces 108, 112 enables an operator to easily engage an attachment with the power unit 102 while operating the power unit from the rear 107 thereof.

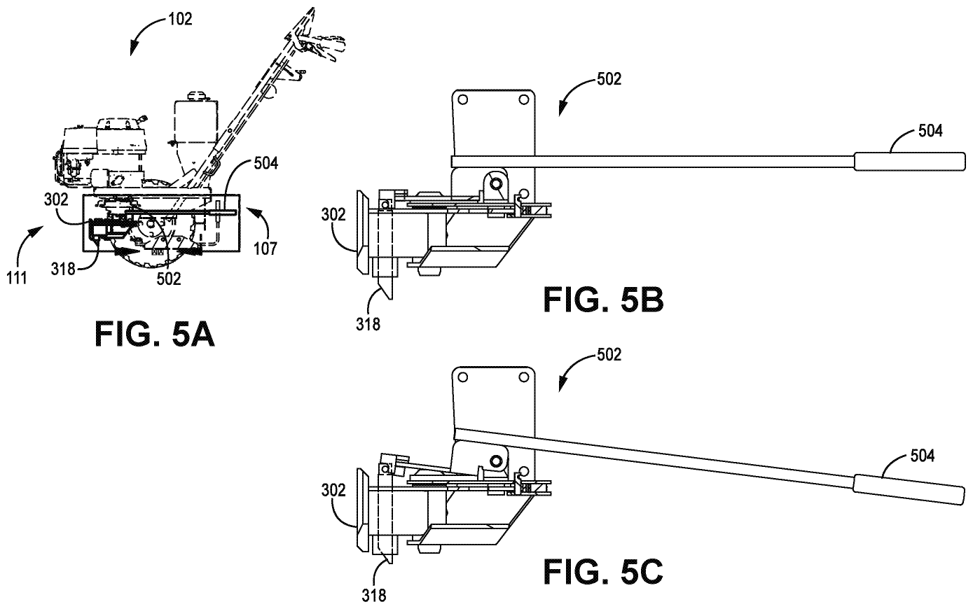

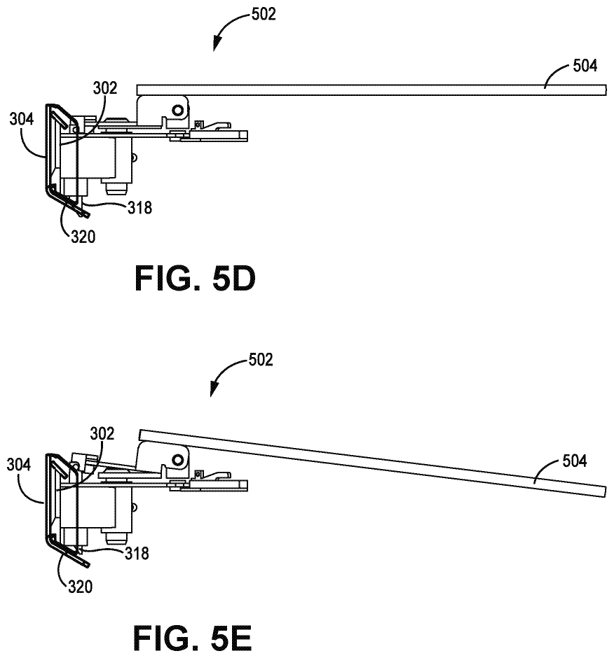

FIGS. 5A-5E are different views showing an example pin position assembly 502 for moving the movable pin(s) 318 of the mounting plate 302. In an example, the power unit 102 can include a pin position assembly 502 that is coupled to the movable pin(s) 318 of the mounting plate 302. FIG. 5A is a side view of the mobile power unit 102 showing portions of the pin position assembly 502. The pin position assembly 502 provides a mechanism for the operator to control, from the rear 107 of the power unit 102, the position of the pin(s) 318 (extended or retracted) which are disposed at the power unit interface 102 proximate a front 111 of the power unit 102. In an example, the pin position assembly 502 includes a handle 504 disposed at the rear 107 of the power unit 102 that controls the position of the pin(s) 318. Movement of the handle 504 between two positions moves the pin(s) 318 correspondingly between the extended position and the retracted position.

FIG. 5B illustrates the pin position assembly 502 and the mounting plate 302 with the pins(s) 318 in the extended position. The extended position corresponds to the position in which the pin(s) 318 are extended outward and engaged in their corresponding aperture(s) 320 of the mating plate 304 (if connected). FIG. 5D illustrates the pin position assembly 502 and the mounting plate 302 with the pin(s) 318 engaged in an aperture 320 of a mating plate 304. FIG. 5C is a side view of the pin position assembly and the mounting plate 302 with the pin(s) 318 in the retracted position. The retracted position is the opposite position to the extended position. In the retracted position the pin(s) 318 are not-extended and are accordingly withdrawn from their corresponding aperture(s) 320. Figure SE is a side view of the pin position assembly 502 and the mounting plate 302 with the pin(s) 318 retracted from the aperture 320 of a mating plate 304.

The handle 504 can cause the pin(s) 318 to move between extended and retracted positions in any appropriate manner including by hydraulic force, electric signal and actuator, cable, or mechanical linkage. In the example shown in FIGS. 5A-5E, the handle 504 is part of a lever that moves the pin 318 via mechanical linkage. Advantageously, inclusion of a pin position assembly 502 along with the mounting plate 302 enables and attachment 110 to be connected and secured to, as well as disconnected from, the power unit 102 all while the operator of the power unit 102 is positioned at the rear 107 thereof.

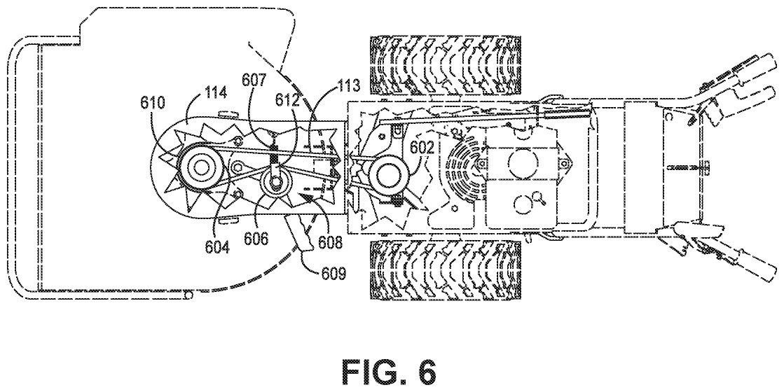

FIG. 6 is a top view of the attachment 110 connected to the power unit 102 with portions of the safety guard 114 and the power unit 102 cut-away to see the belt 113 and corresponding pulleys underneath. This attachment 110 is a powered attachment that is powered by a belt drive from the power unit 102. The power unit 102 includes a drive pulley 602 that is coupled to the power source 104 of the power unit 102. The power source 104 is configured to rotate the drive pulley 602 in response to control by the operator of the power unit 102. The drive pulley 602 can be disposed proximate the power unit interface 108 of the power unit 102 and in a manner such that the drive pulley 602 is accessible from the front of the unit 102. This accessibility enables the belt 113 to be engaged on the drive pulley 602 and extend to the attachment 110 to provide power thereto. The drive pulley 602 can define one or multiple grooves for engaging the one or multiple belts 113 (e.g., V-belts).

The attachment 110 includes one or more driven pulleys 604. The driven pulley(s) 604 can be disposed on the attachment 110 in any suitable manner such that the belt(s) 113 that engage the drive pulley 602 also engage the driven pulley(s) 604. The driven pulley(s) 604 can be coupled to a driven component of the attachment 110, such as a mower blade, powered brush, snow blower auger, or tiller blades, such that rotating the driven pulley(s) 604 also rotates the coupled driven component. The driven pulley(s) 604 can define one or more grooves for engaging the one or more belts 113.

The attachment 110 can also include one or more idler pulleys 606. The one or more idler pulleys 606 can each define at least one groove for the belt(s) 113. As is common for idler pulleys, the groove(s) in the idler pulley(s) 606 can have a different cross-section than the groove(s) in the drive and driven pulleys 602, 604. For example, the grooves in the drive and driven pulleys 602, 604 can have a cross-section that matches the cross-section of the belt(s) 113, enabling the belt(s) 113 to grip the drive and driven pulleys 602, 604 sufficiently to transfer power therebetween. Since the idler pulley(s) 606 only guide the position of the belt(s) 113, no power transfer is needed, so the groove(s) in the idler pulley(s) 606 can be much shallower and broader than the grooves in the drive and driven pulleys 602, 604. In an example, the groove in the idler pulley 606 can be composed of a flat bottom with small flanges on either side to maintain the belt(s) 113 therebetween. In an example, the groove in the idler pulley 606 is configured to contact the flat (wider) back side of the V-type belt(s).

At least a first of the idler pulleys 606 can have a tensioner 607 coupled thereto to provide tension to the belt(s) 113 engaged between a driven pulley(s) 604 and the drive pulley 602. Any suitable tensioner can be used including a spring. The attachment 110 can also include an idler position assembly 608 coupled to the first idler pulley 606. The idler position assembly 608 is a mechanical structure coupled to the first idler pulley 606 that enables the first idler pulley 606 to be set into two different positions. A first (engaged) position is where the first idler pulley 606 is fully engaged with the belt(s) 113 such that the tensioner 607 is providing tension to the belt(s) 113 via the first idler pulley 606. The engaged position enables the belt(s) 113 to remain engaged with the drive and driven pulleys 602, 604 while looping at full operational speed. A second (disengaged) position is where the first idler pulley 606 is retracted from its fully engaged position such that the tension on the belt 113 is released allowing the belt 113 to be removed from the drive pulley 602. The disengaged position is not suitable for looping at full operational speed due to the lack of sufficient tension on the belt(s) 113.

The idler position assembly 608 can include a handle 609 by which an operator can move the handle 609 to move the first idler pulley 606 between the engaged and disengaged positions. In an example, the idler position assembly 608 includes a mechanism (e.g., detent, latch) to hold the first idler pulley 606 in the disengaged position, such that the first idler pulley 606 will remain in the second position while an operator has removed their hand(s) from the handle. In an alternative example, the idler position assembly 608 can spring back to the engaged position automatically if an operator removes their hand(s) from the handle while the first idler pulley 606 is in the disengaged position. In either case, the idler position assembly 608 is configured such that once the idler pulley 606 is placed in the engage position, the idler pulley 606 remains in the engaged position without operator assistance for operation of the powered component of the attachment 110, until an operator moves the handle 609 to move the idler pulley 606 out of the engaged position and into the disengaged position. FIG. 6 shows the idler pulley 606 in an example engaged position.

The idler position assembly 608 can be used by the operator to easily install and remove the belt(s) 113 from the drive pulley 602 during connection and disconnection of the attachment 110 to/from the power unit 102. For example, after connection of the attachment interface 112 of the attachment 110 to the power unit interface 108 of the power unit 102, the operator can install the belt(s) 113 onto the drive pulley 602 for powering of the attachment 110. To do so, the operator can move the handle of the idler position assembly 608 to move the idler pulley 606 to the disengaged position, thereby releasing the tension on the belt(s) 113. With the tension released, the belt(s) 113 can more easily be placed on the drive pulley 606 and engaged into the groove(s) of the drive pulley 602. Once the belt(s) 113 are engaged with the drive pulley 602, the operator can move the handle of the idler position assembly 608 to place the idler pulley into the engaged position. With the idler pulley 602 in the engaged position, the powered component(s) of the attachment 110 can be operated.

The attachment 110 can also include a first belt guide 610 to maintain the belt(s) 113 aligned with their corresponding groove in the driven pulley 604 while tension on the belt(s) 113 is released. The first belt guide 610 is a structure disposed in an opposing relationship to the one or more grooves of the driven pulley 604. In particular, the first belt guide 610 is disposed close enough to the one or more grooves of the driven pulley 604 that the belt(s) 113 will not fall out from alignment with their respective groove while tension is released on the belt(s) 113. Notably, the first belt guide 610 can, but does not need to maintain the belt(s) 113 fully engaged into their groove while tension is released, only aligned with their groove such that when tension is applied to the belt(s) 113, the tension pulls the belt(s) 113 back into engagement with its groove. In an example, the first belt guide 610 can be a member that is integral with and extends (e.g., downward) from the safety guard 114.

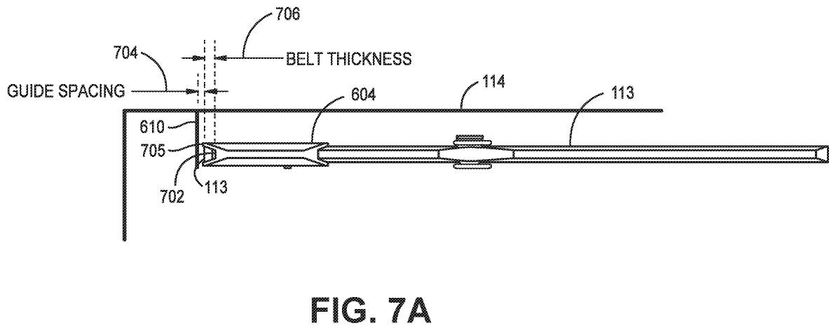

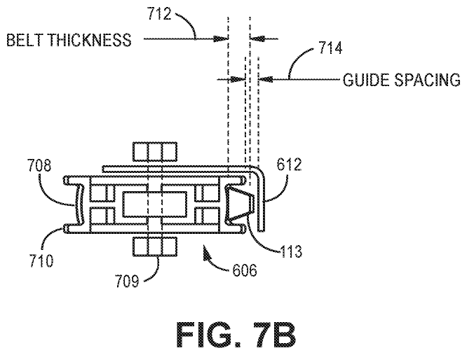

FIG. 7A is a cross-sectional view of an example first belt guide 610 for the driven pulley 604 showing the belt 113 engaged with its groove 702 on the driven pulley. In this example, the first belt guide 610 is a sheet that extends from the safety guard 114 proximate the driven pulley 604. In an example, the first belt guide 610 is disposed closer in distance 704 to a rim 705 of the groove 702 than a thickness 706 of the belt 113, such that the belt 113 cannot easily slip between the first belt guide 610 and the rim 705 of the pulley 604. By restricting movement of the belt 113 such that it cannot extend outside of the rims (edges) 705 of the groove 702, the first belt guide 610 maintains alignment of the belt 113 with the groove 702 when tension on the belt 113 is released.

Referring back to FIG. 6, the first belt guide 610 can, but need not, be disposed around the entire portion of the driven pulley 604 that is engaged by the belt(s) 113. In some examples, the first belt guide 610 is disposed opposite only a portion of the portion of the driven pulley 604 that is engaged by the belt(s) 113. Moreover, the first belt guide 610 can be a single component (e.g., post or elongated surface) of desired length or can be composed of multiple spaced apart components, each opposed to a respective portion of the driven pulley 604. In any case, the first belt guide 610 is disposed opposite enough of the driven pulley 604 to keep the belt(s) 113 aligned with their groove, such that the belt(s) 113 engage with their corresponding groove when tension is applied by the idler pulley 606.

The attachment 110 can also include a second belt guide 612 to maintain the belt(s) 113 aligned with their corresponding groove in the first idler pulley 606 while tension on the belt(s) 113 is released. Similar to the first belt guide 610, the second belt guide 612 is a structure disposed in an opposing relationship to the one or more grooves of the first idler pulley 606. The second belt guide 612 is disposed close enough to the one or more grooves of the idler pulley 606 that the belt(s) 113 will not fall out of alignment with its respective groove while tension is released. Similar to the first belt guide 610, the second belt guide 612 can, but does not need to maintain the belt(s) 113 fully engaged into their groove in the idler pulley 606 while tension is released, only aligned with the groove such that when tension is applied to the belt(s) 113, the tension pulls the belt(s)113 back into engagement with its groove. The second belt guide 612 can be disposed around all or a portion of the portion of the idler pulley 606 contacted by the belt(s) 113. The second belt guide 612 can be composed of a single component (e.g., post or elongated surface) of desired length or can be composed of multiple spaced apart components, each opposed to a respective portion of the idler pulley 606. In any case, the second belt guide 612 is disposed opposite enough of the idler pulley 606 to keep the belt(s) 113 aligned with their groove.

FIG. 7B is a cross-sectional view of an example second belt guide 612 for the idler pulley 606 showing the belt 113 engaged with its groove 708 on the idler pulley 606. In this example, the second belt guide 612 is an arm that extends from an axle 709 of the idler pulley 606 and includes a portion that extends opposite the portion of the groove 708 in which the belt 113 is engaged. In an example, the second belt guide 612 is disposed in closer distance 714 to a rim 710 of the groove 708 than a thickness 712 of the belt 113, such that the belt 113 cannot easily slip between the second belt guide 612 and the rim 710 of the pulley 606. By restricting movement of the belt 113 such that it cannot extend outside of the rims (edges) 710 of the groove 708, the second belt guide 612 maintains alignment of the belt 113 with the groove 708 when tension on the belt 113 is released.

In an example, the second belt guide 612 is disposed to maintain the belt(s) 113 aligned with the first idler pulley 606, which applies tension to the belt(s) 113 with the tensioner 607. In such an example, the second belt guide 612 can be integrated with the physical support structure for the first idler pulley 606, such that the second belt guide 612 moves with the first idler pulley 606 when the first idler pulleys 606 moves between the engaged and the disengaged positions. By moving with the first idler pulley 606, the second belt guide 612 can maintain its opposing position and distance from the first idler pulley 606 to ensure the belt(s) 113 stay aligned with their groove of the idler pulley 606 while the first idler pulley 606 moves between the engaged and disengaged position and while the first idler pulley 606 is in the disengaged position. In the example shown in FIGS. 6 and 7B, the second belt guide 612 is an arm that extends from a support structure for the axle of the first idler pulley 606 and is disposed across the groove(s) 708 of the first idler pulley 606. Other structures can also be used. Although an example spacing and belt thickness are shown in FIGS. 7A and 7B, it should be understood that other spacings and belt thicknesses can also be used.

The first and second belt guides 610, 612 keep the belt(s) 113 aligned with their respective pulleys 604, 606 while tension is released on the belt(s) 113. This allows an operator to quickly re-connect to an attachment 110. For example, after an attachment 110 is used, the operator will remove the belt(s) 113 for that attachment 110 from the drive pulley 602 of the power unit 102 and disconnect the attachment 110 from the power unit interface 108. During and after this disconnection process, the first and second belt guides 610, 612 will keep the belt(s) 113 aligned with the driven pulley 604 and the idler pulley 606. Thus, when the operator is reconnecting the attachment 110 to the power unit 102 for its next use, the belt(s) 113 will already be aligned with the driven pulley 604 and the idler pulley 606. The operator, therefore, does not need to place the belt(s) 113 onto the driven pulley 604 or the idler pulley 606. The operator simply connects the attachment 110 to the power unit interface 108, places the belt(s) 113 onto the drive pulley 602, and moves the first idler pulley 606 in the engaged position. This can decrease the time required for connecting to the attachment 110 and improve the operator satisfaction. Additionally, by holding the belt(s) 113 onto its pulleys 604, 606 of the attachment 110, the belt(s) 113 is less likely to be lost during periods of disconnection (e.g., transport) of the attachment. This can save the operator time by eliminating the requirement to locate and/or otherwise obtain a belt(s) 113 to power the attachment 110. Additionally, by not having to place the belt(s) 113 on the driven pulley 604 and the first idler pulley 606, the operator can hook-up the belt(s) 113 without having to remove a safety guard 114 for the pulleys 604, 606 or belt 113. This also increases safety by lessening the temptation to take the safety guard 114 off permanently to avoid having to remove and replace it each time the attachment 110 is connected/disconnected. In an example, the attachment 110 and its guards and pulley arrangement are configured such that the portion of the belt(s) 113 that would attach to the drive pulley 602 are accessible outside of the guard(s) 114 when the attachment 110 is disconnected. This enables the operator to connect the belt(s) 113 to the drive pulley 604 without having the locate it under the guard(s) 114.

Although only a single driven pulley 604 and a single idler pulley 606 are shown in the example of FIG. 6, more than one driven pulley 604 and or more than one idler pulley 606 can be used. In some examples, the attachment 110 includes also includes one or more secondary pulleys (e.g., driven and/or idler). As used herein a “secondary pulley” on an attachment 110 is a pulley that is engaged with a belt that is not also engaged (or to-be engaged) with the drive pulley 602. That is, a secondary pulley is engaged by a belt in series with the belt(s) that engage the drive pulley 604. For example, a three-blade mower attachment may have a first belt(s) that engage the drive pulley 602, a first driven pulley, and a first idler pulley. The first driven pulley may be coupled to a first blade of the mower. A second and third secondary driven pulleys may be coupled to the second and third blades of the mower respectively. The second and third secondary driven pulleys can be engaged by a respective belt that engages the first driven pulley but does not engage the drive pulley 602. Instead, second and third secondary pulleys receive power indirectly from the drive pulley 602 via the first driven pulley. The belt(s) that engage the drive pulley are also referred to herein as “primary” belt(s) and pulleys engaged by the primary belt(s) are also referred to herein as “primary” pulleys. In an example, each primary pulley of the attachment has a corresponding belt guide (e.g., 610, 612) to maintain the primary belt(s) engaging that primary pulley aligned with its corresponding groove while tension on the primary belt(s) is released as discussed above.

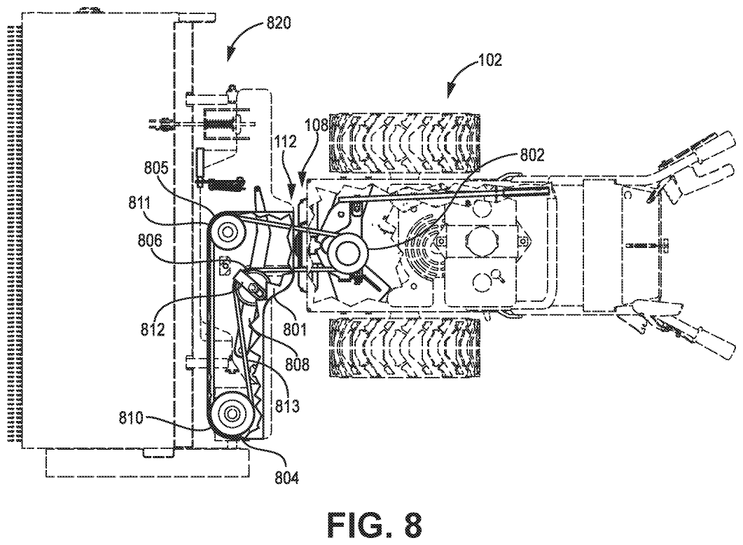

FIG. 8 is a top view of another example attachment 820 connected to the power unit 102 of FIG. 1 with a portion of the safety guard 801 and power unit 102 cut-away to show the belt 813 and corresponding pulleys. This attachment 820 is a powered brush. The attachment 820 can include an attachment interface 112 that connects to the power unit interface 108 as described above. The attachment 820 also includes a driven pulley 804 and two idler pulleys 805, 806, each engaged with the primary belt 813 that also engages a drive pulley 802. A first idler pulley 806 is coupled to an idler pulley position assembly 808, which enables an operator to move the first idler pulley 806 between the engaged and disengaged position.

The attachment 820 can also include belt guides 810, 811, 812. Similar to belt guides 610 and 612, belt guides 810, 811, 812 are surfaces and/or members that are disposed opposing a portion of the groove of their corresponding pulley 804, 805, 806 to maintain the belt 813 aligned with the corresponding groove while tension on the belt 813 is released. In the example shown in FIG. 8, the belt guides 810 and 811 are portions of the outer wall of the safety guard 801 that are disposed adjacent the corresponding pulleys 804 and 805. The belt guide 812 is integral with the support structure for the idler pulley 806, such that the belt guide 812 moves with the idler pulley 806 similar to the belt guide 612 discussed with respect to FIG. 6.

Other types of attachments can also include their portion of the belt-driven attachment system described herein, such as a snow blower, tiller, power rake/soil conditioner, plow blade, stump grinder, tiller, edger/trencher, wood chipper, pressure washer, log splitter, rotatable drum, cutting wheel, pump, flywheel, or lawn aerator attachment.

What is claimed is:

1. A belt-driven attachment system comprising:
a mobile power unit including:
a plurality of wheels or tracks;
a drive pulley;
a power source coupled to the plurality of wheels or tracks to provide motive power for the mobile power unit, the power source coupled to the drive pulley to rotate the drive pulley; and
a power unit interface; and
an attachment for the mobile power unit, the attachment including:
an attachment interface configured to removably secure the attachment to the mobile power unit by fastening to the power unit interface of the mobile power unit;
at least one driven pulley defining at least one groove for a belt;
a first belt guide opposing a portion of the at least one groove of the at least one driven pulley, the first belt guide configured to maintain the belt aligned with the at least one groove of the at least one driven pulley when tension on the belt is released;
an idler pulley defining at least one groove for the belt;
a tensioner coupled to the idler pulley to provide tension on the belt;
an idler position assembly coupled to the idler pulley, the idler position assembly providing a first position setting for the idler pulley in which tension on the belt is maintained and a second position setting for the idler pulley in which tension on the belt is released; and
a second belt guide opposing a portion of the at least one groove of the idler pulley, the second belt guide configured to maintain the belt aligned with the at least one groove of the idler pulley when tension on the belt is released.

2. The attachment system of claim 1, wherein the attachment includes:
one or more guards covering the at least one driven pulley and the idler pulley to protect from human contact with the at least one driven pulley and the idler pulley during operation.

3. The attachment system of claim 1, wherein the power unit interface of the mobile power unit includes a mounting plate,
wherein the mating coupler includes a mating plate configured to bear against the mounting plate, the mating plate defining a flange that hooks onto the mounting plate.

4. The attachment system of claim 3, wherein the mounting plate includes:
a movable pin configured to extend through an aperture to secure the mating plate to the mounting plate and to retract from the aperture to release the mating plate from the mounting plate.

5. The attachment system of claim 4, wherein the mobile power unit includes:
a pin position assembly coupled to the movable pin such that an operator can engage and retract the pin from the aperture by moving a handle at a rear of the mobile power unit.

6. The attachment system of claim 1, comprising:
a handle coupled to the idler position assembly such that an operator can move the idler pulley between the first position setting and the second position setting by moving the handle.

7. The attachment system of claim 1, wherein the mobile power unit is a walk-behind unit.

8. The attachment system of claim 1, wherein the attachment includes one of a mower, powered brush, snow blower, tiller, power rake/soil conditioner, plow blade, stump grinder, tiller, edger/trencher, wood chipper, pressure washer, log splitter, rotatable drum, cutting wheel, pump, flywheel, or lawn aerator attachment.

9. An attachment for a mobile power unit, the attachment comprising:
an interface configured to removably attach to the mobile power unit;
at least one driven pulley defining at least one groove for a belt;
a first belt guide opposing the at least one groove of the at least one driven pulley to maintain the belt aligned with the at least one groove of the at least one driven pulley when operating tension on the belt is released;
an idler pulley defining at least one groove for the belt;
a tensioner coupled to the idler pulley;
an idler position assembly coupled to the idler pulley, the idler position assembly configured to move the idler pulley between a first position and a second position, the first position maintaining operating tension on the belt and the second position having operating tension released; and
a second belt guide opposing the at least one groove of the idler pulley to maintain the belt aligned with the idler pulley when operating tension on the belt is released.

10. The attachment of claim 9, comprising:
one or more guards covering the at least one driven pulley and the idler pulley to protect from human contact with the at least one driven pulley and the idler pulley during operation.

11. The attachment of claim 9, wherein the interface includes a mating plate configured to bear against a mounting plate of the mobile power unit, the mating plate defining a flange that hooks onto the mounting plate.

12. The attachment of claim 9, comprising:
a handle coupled to the idler position assembly such that an operator can move the idler pulley between the first position and the second position by moving the handle.

13. The attachment of claim 12, wherein the idler position assembly is configured to hold the idler pulley in the second position while an operator has released the handle.

14. The attachment of claim 9, wherein the mobile power unit is a walk-behind unit.

15. The attachment of claim 9, wherein the at least one driven pulley is coupled to at least one driven component selected from to group consisting of: a mower blade, a rotatable brush, a snow auger, a tiller blade, a rotatable rake, a water pump, a rotatable drum, a cutting or grinding wheel, and a flywheel.

16. A walk-behind power unit comprising:
a frame;
a single axle for a plurality of wheels mounted on the frame;
an operator interface at a rear of the walk-behind power unit, the operator interface including a plurality of handle bars rigidly coupled to the frame for non-assisted maneuvering of the power unit by an operator walking behind;
a drive pulley mounted on the frame for providing belt-driven power to a powered attachment;
a power source mounted on the frame, the power source coupled to the plurality of wheels to provide motive power for the power unit, the power source coupled to the drive pulley to rotate the drive pulley; and
a mounting plate at a front of the walk-behind power unit, the mounting plate configured to have the powered attachment removably mounted thereto, the mounting plate defining:
a vertically oriented contact surface for contacting a corresponding surface of the powered attachment, and
an edge for engaging a flange of the powered attachment.

17. The walk-behind power unit of claim 16, comprising:
a movable pin configured to extend through an aperture in the attachment to secure the powered attachment to the mounting plate and to retract from the aperture to release the powered attachment from the mounting plate.

18. The walk-behind power unit of claim 17, comprising:
a pin position assembly coupled to the movable pin such that an operator can engage and retract the pin from the aperture by moving a handle at the rear of the walk-behind power unit.

19. The walk-behind power unit of claim 17, wherein the contact surface of the mounting plate is oriented normal to, or includes position setting that is oriented normal to, a forward direction of travel of the walk-behind power unit.

20. The walk-behind power unit of claim 17, wherein the powered attachment includes one of a mower, powered brush, snow blower, tiller, power rake/soil conditioner, plow blade, stump grinder, tiller, edger/trencher, wood chipper, pressure washer, log splitter, or lawn aerator attachment.
